(19) United States
(12) Patent Application Publication
(10) Pub. No.: US 2009/0233716 A1
(43) Pub. Date: Sep. 17, 2009

(54) System and Method for Investing in Poker Players

(76) Inventor: Gregory L. Cash, Mount Ida, AR (US)

Correspondence Address: GREENBERG TRAURIG, 3773 HOWARD HUGHES PARKWAY, SUITE 500 NORTH, LAS VEGAS, NV, 89169, US

(21) Appl. No.: 12/034,546

(22) Filed: Feb. 20, 2008

Related U.S. Application Data
(60) Provisional application No. 60/890,793, filed on Feb. 20, 2007.

(51) Int. Cl. A63F 9/24; G06Q 40/00

(52) U.S. Cl. 463/42; 463/25; 705/39

(57) ABSTRACT

A system and method of allowing poker players to receive funding from one or more interested investors. An online website provides a location for investors to find players interested in seeking investor backing. The website includes player information, tournament information and similar information needed by an investor to determine which player or players to invest in. Investors invest by providing money for tournament buy-ins. The investment may be all or a percentage of the buy-in. The amount of the investment relative to the buy-in or entry fee dictates how much of a winning amount, if any, the investor stands to receive.

### CROSS-REFERENCE

This application claims the benefit of Provisional Patent Application No. 60/890,793 filed on Feb. 20, 2007.

### FIELD OF THE INVENTION

The embodiments of the present invention relate to an electronically implemented method and system for investing in poker players. More particularly, investing in the performance of poker players with returns coming in the form of a percentage of poker player winnings.

### BACKGROUND

As a result of televised poker tournaments and online poker websites, poker has become a mainstream game. Indeed, television has created celebrities out of heretofore anonymous poker players. Online poker websites have encouraged millions of new poker players to learn and play poker. However, even with the exploding popularity of poker, many up and coming players have difficulty raising the stakes or entry fees associated with playing poker regularly. Also, other individuals may not want to play poker but have an interest in participating in the rewards associated with poker tournaments and even live poker games.

It is known in the poker world that many players professional or amateur are staked or otherwise backed financially in return for a percentage of any amounts the player wins. However, such arrangements are facilitated by handshake deals and only allow those on the inside to participate. With the advent of multimedia outlets, it would be advantageous to allow a more broad segment of the public to participate as staked players and/or as investors willing to stake players.

Thus, there is a need for a method and system for allowing poker players to receive financial backing and individuals to back poker players of their choice.

### SUMMARY

Accordingly, a first embodiment of the present invention is a method of conducting a poker player investor scheme comprising: via a computer: providing poker players with the ability to register for an opportunity to receive financial backing from third parties; providing said third parties with access to registered poker players and corresponding events which said poker players intend to enter; providing means for said third parties to fund one or more poker players of their choice wherein said funding is used to pay all, or portions of, entry fees associated with events to be participated in by the one or more funded poker players; and providing said third parties with a percentage of any winnings realized by the corresponding funded poker players.

Another embodiment is a computer storage medium comprising: code for allowing poker players to register for an opportunity to receive financial backing from third parties; code for providing said third parties with access to registered poker players and corresponding events which said poker players intend to enter; code for providing means for said third parties to fund one or more poker players of their choice wherein said funding is used to pay all, or portions of, entry fees associated with events to be participated in by the one or more funded poker players; and code for providing said third parties with a percentage of any winnings realized by the corresponding funded poker players.

Another embodiment is a computer programmed to: allow poker players to register for an opportunity to receive financial backing from third parties; provide said third parties with access to registered poker players and corresponding events which said poker players intend to enter; provide means for said third parties to fund one or more poker players of their choice wherein said funding is used to pay all, or portions of, entry fees associated with events to be participated in by the one or more funded poker players; and to provide said third parties with a percentage of any winnings realized by the corresponding funded poker players.

The embodiments of the present invention allow any third party to invest in any poker player(s) of their choice. In addition, the embodiments allow any poker player, regardless of skill level, to seek funding from third parties.

Other variations, embodiments and features of the present invention will become evident from the following detailed description, drawings and claims.

### BRIEF DESCRIPTION OF THE DRAWINGS

FIGS. 1a-1g illustrates an exemplary series of computer-implemented web pages for facilitating the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

In one embodiment, the method and system disclosed herein are facilitated by computer software, storage mediums and/or a dedicated website where any number of remotely located participants are able to utilize the method and system. Such websites and the software associated herewith are well-known in the art and need not be described with great detail herein. Moreover, the embodiments of the present invention may be used with cash games or tournaments, but for the sake of brevity, tournament play is focused on herein to detail the embodiments of the present invention.

Initially, poker players are able to access and register via a dedicated website facilitating the embodiments of the present invention. Poker players register by providing personal information used to verify the identity of the registering poker player. Poker players may also be required to pay an optional registration fee for the privilege of attracting investors or backers. Registering poker players also provide a resume or profile of their historic poker play. The profile is designed to inform potential investors of the skill level of the participating poker players thereby encouraging investor monies. In addition, poker players input events that the players intend to enter and the corresponding entry fee. After the registration process is complete, the poker players need only monitor the investments that have been received on their behalf and update their event schedule.

Once poker players are registered, investors or backers are able to visit the dedicated website and view poker player profiles and tournaments schedules. Investors may now register with the website as an investor. Optionally, investors may have to pay an pre-established registration fee. Besides personal information, investors must fund an account. In one embodiment, the account is an escrow account. Upon registration and funding, the investors must select which one or more players to back, in which events to back the one or more players and how much to fund each player during each event. An investor may fund a player with cash, credit card, debit card or any other suitable means. Once the funding process is completed by the investor, adequate funding from the escrow account is directed to the operator of the dedicated website. The funding is then directed electronically or manually to the operator (e.g., casino) of the selected events. In return for the investment, the investor is provided an opportunity to receive a percentage of any winnings realized by the corresponding poker player or poker players. The percentage is adjusted based on the amount of the investment for the specific tournament from which the winnings are realized. For example, if an investor covers an entire entry fee (e.g., $2000), the investor may be apportioned 40% of any winnings realized by the poker player. On the other hand, if the investor covers only one-half of the entry fee (i.e., $1000), the investor is apportioned only 20% of any such winnings. Accordingly, in situations wherein two or more investors back the same player in the same event, multiple investors may share pro-rata in 40% of the winnings. In this example, the player may be apportioned 50% of any winnings and the operator of the dedicated website may be apportioned 10% of the winnings. Those skilled in the art will recognize that countless formulas for calculating shares in the winnings apportioned between the investor, player and website operator may be utilized (e.g., 20% investor, 65% player and 15% website operator).

Any winnings to which an investor is entitled to are funneled through the dedicated website into the escrow account controlled by the investor with the website operator first deducting its share of the winnings. The website operator may have pre-established relationships with the operators of the poker tournaments such that winnings due the player are automatically segregated from the shares due the investor and website operator. Alternatively, the website operator may have agents at the poker tournaments to coordinate apportionment of any winnings directly with the poker tournament operators and/or poker players themselves.

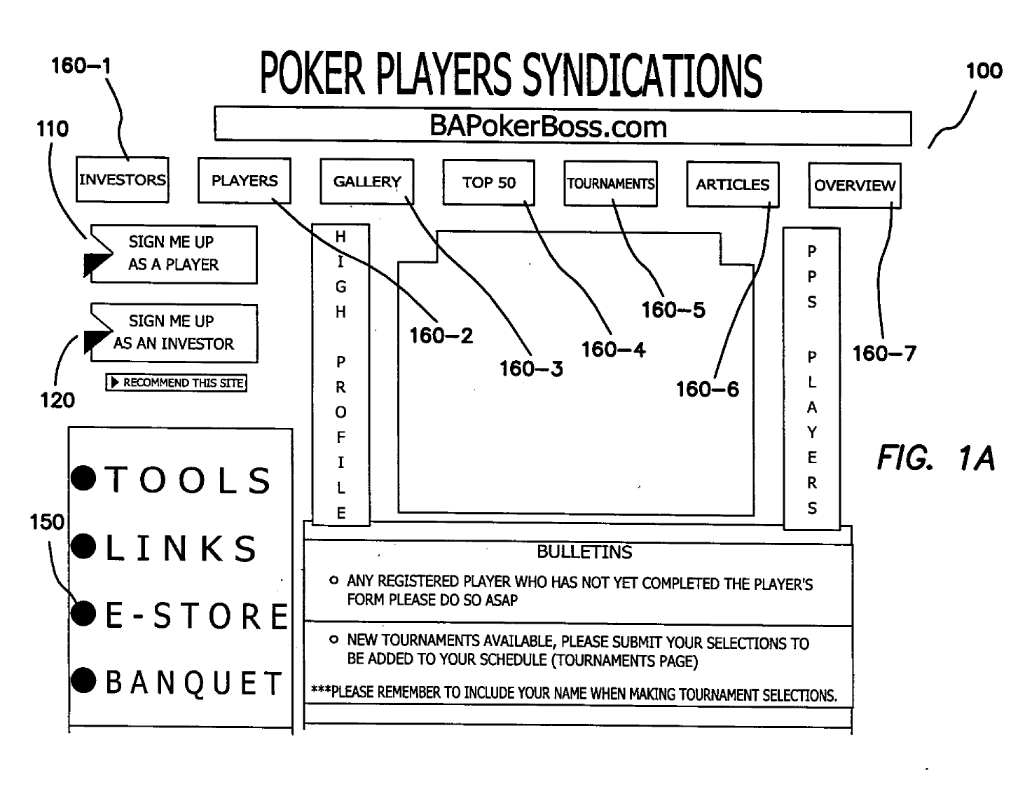

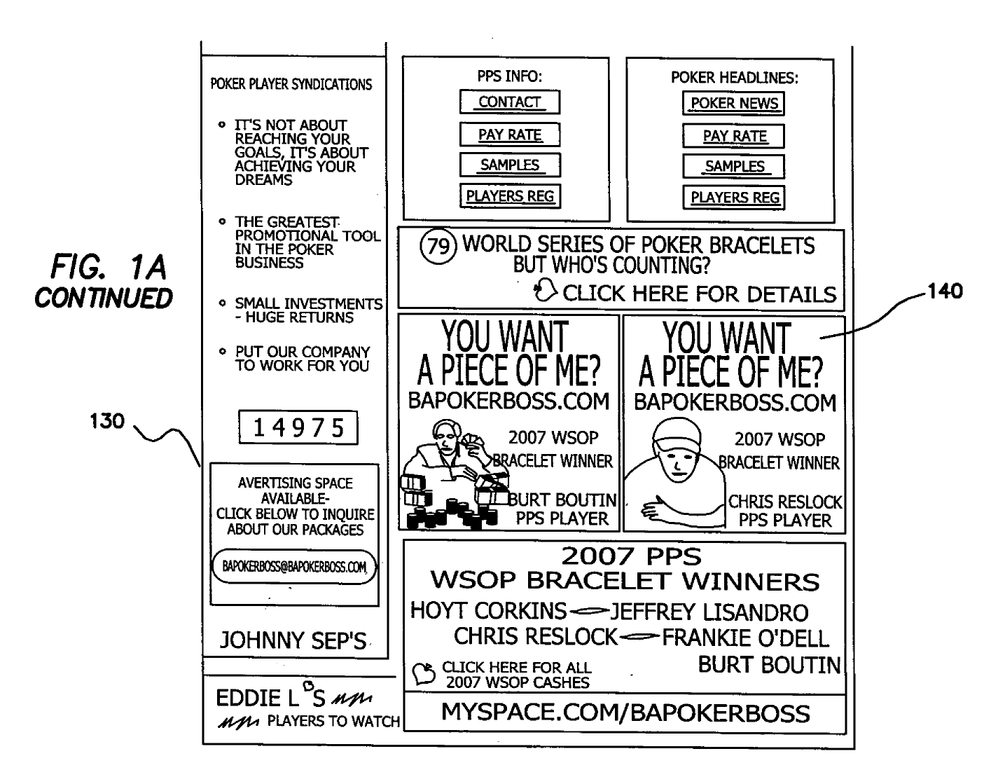

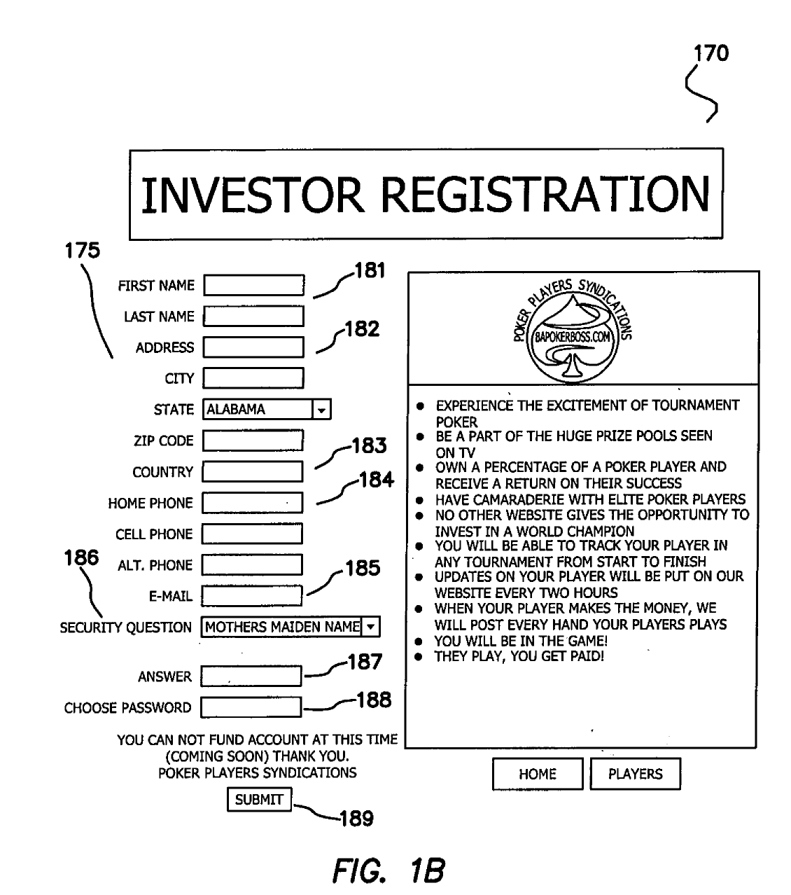

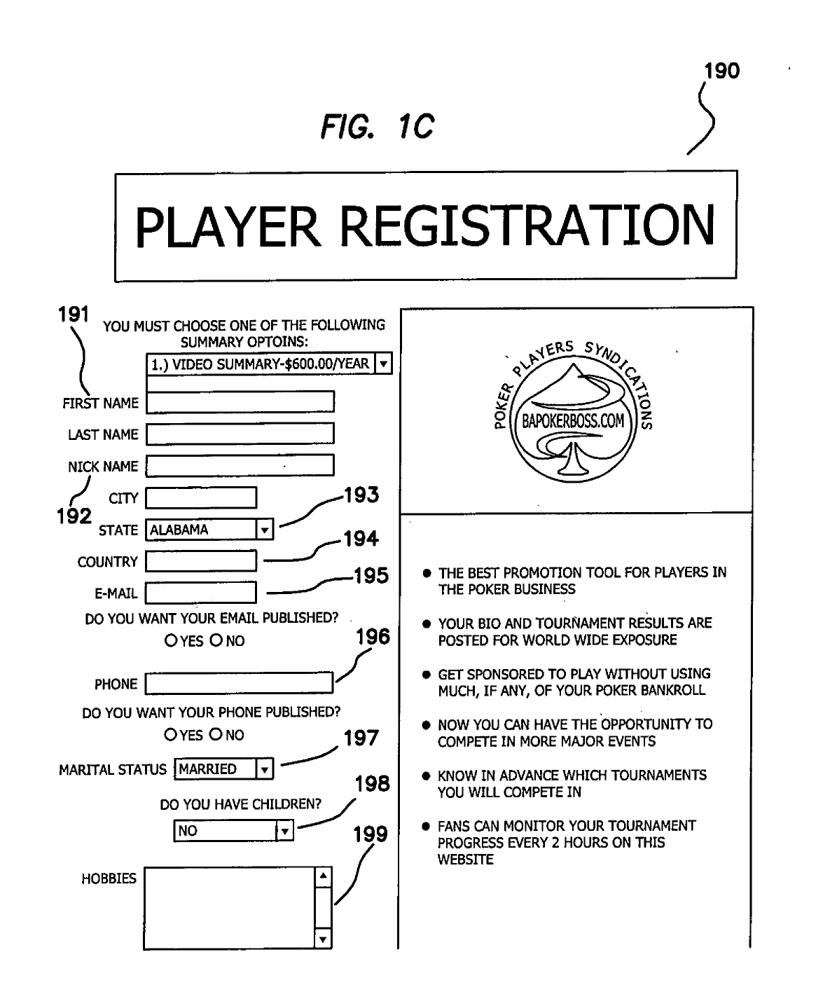

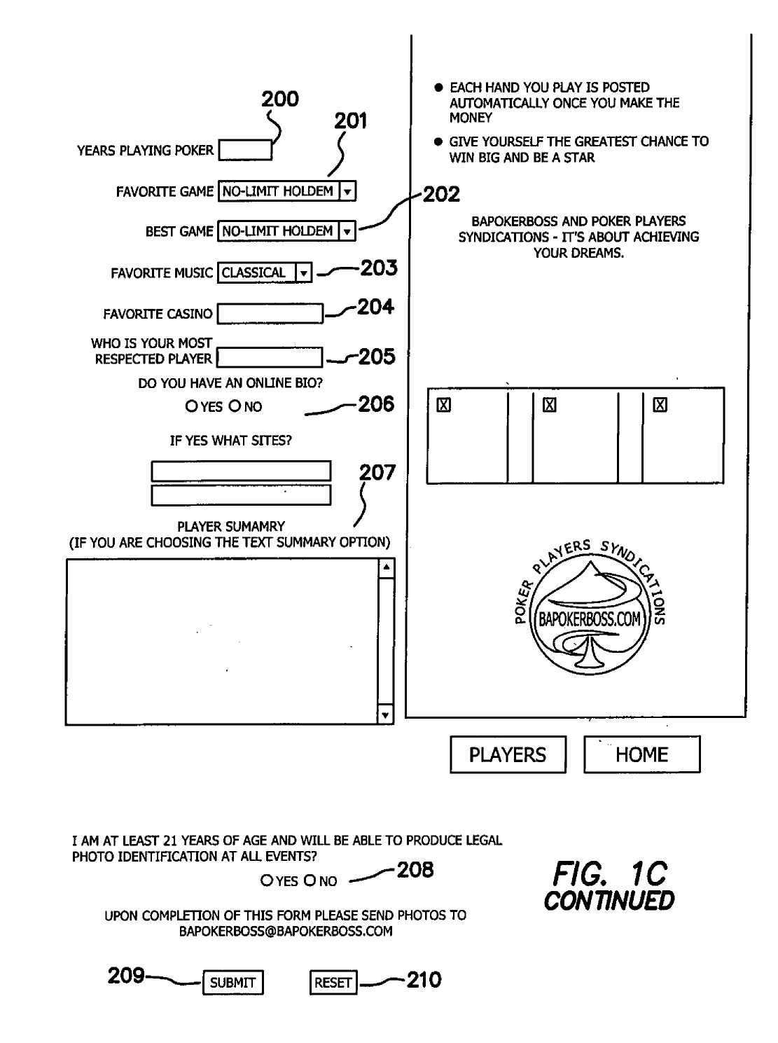

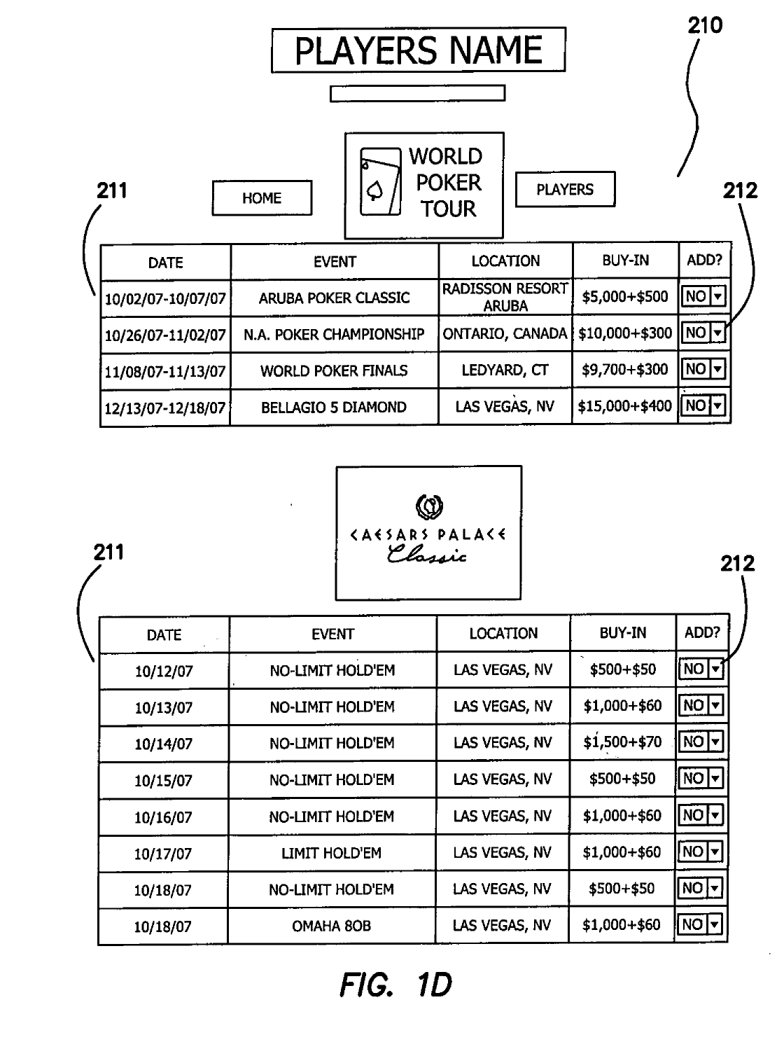

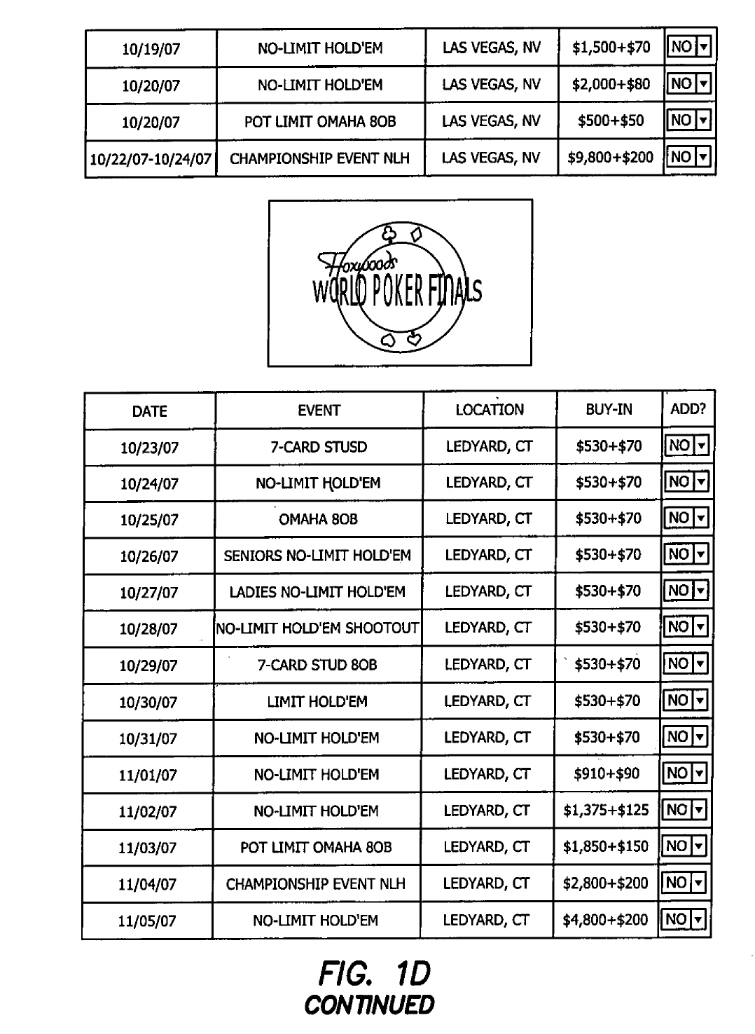

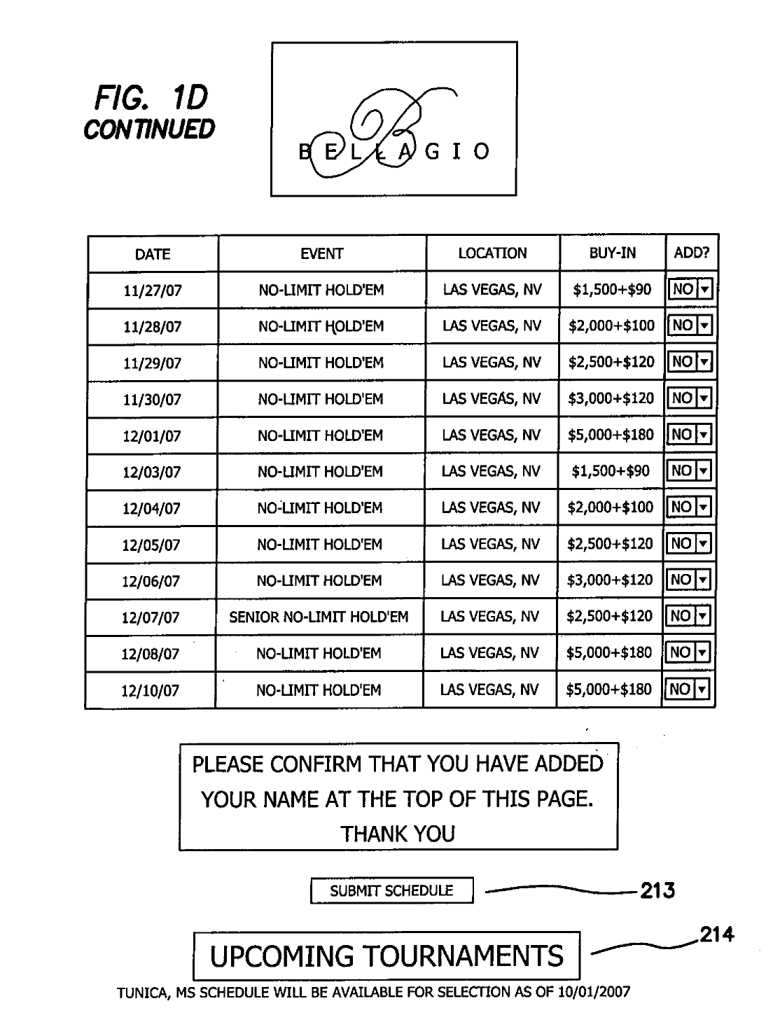

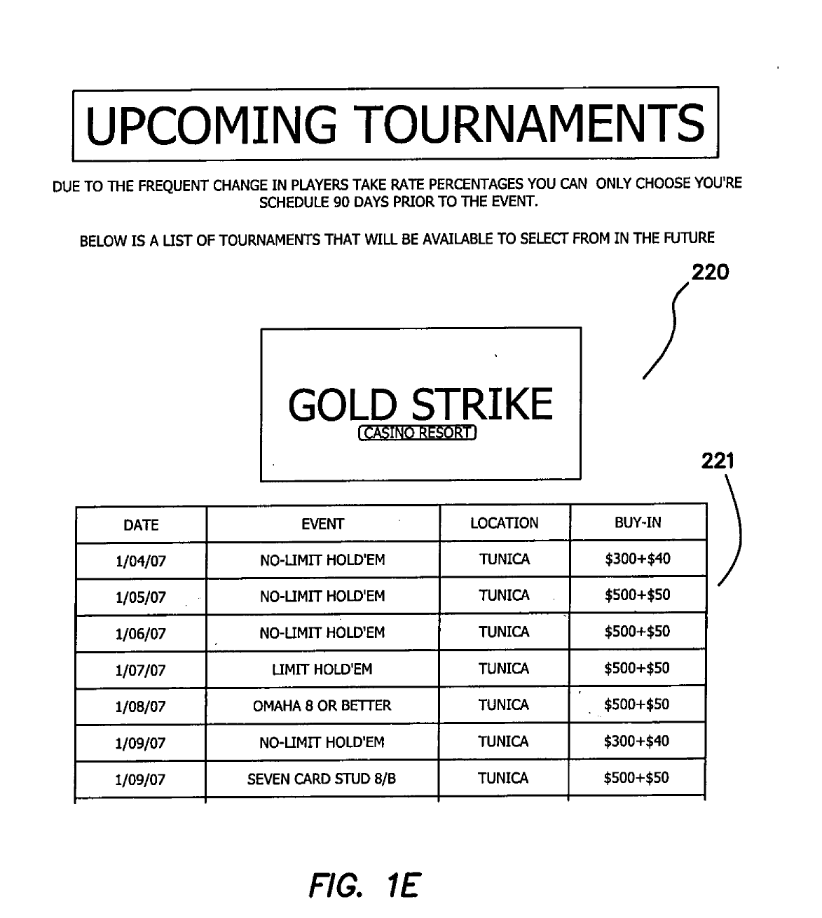

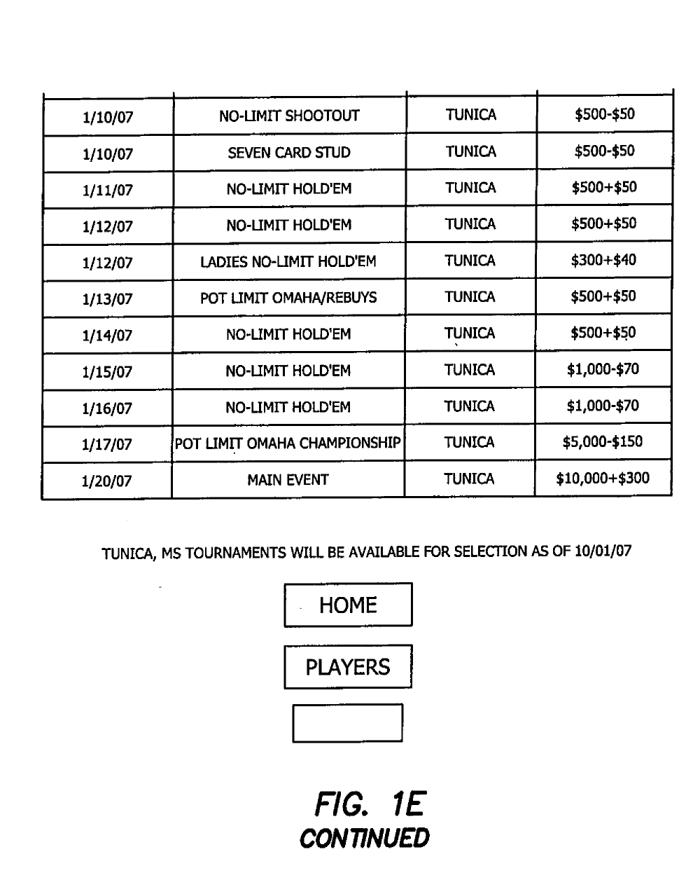

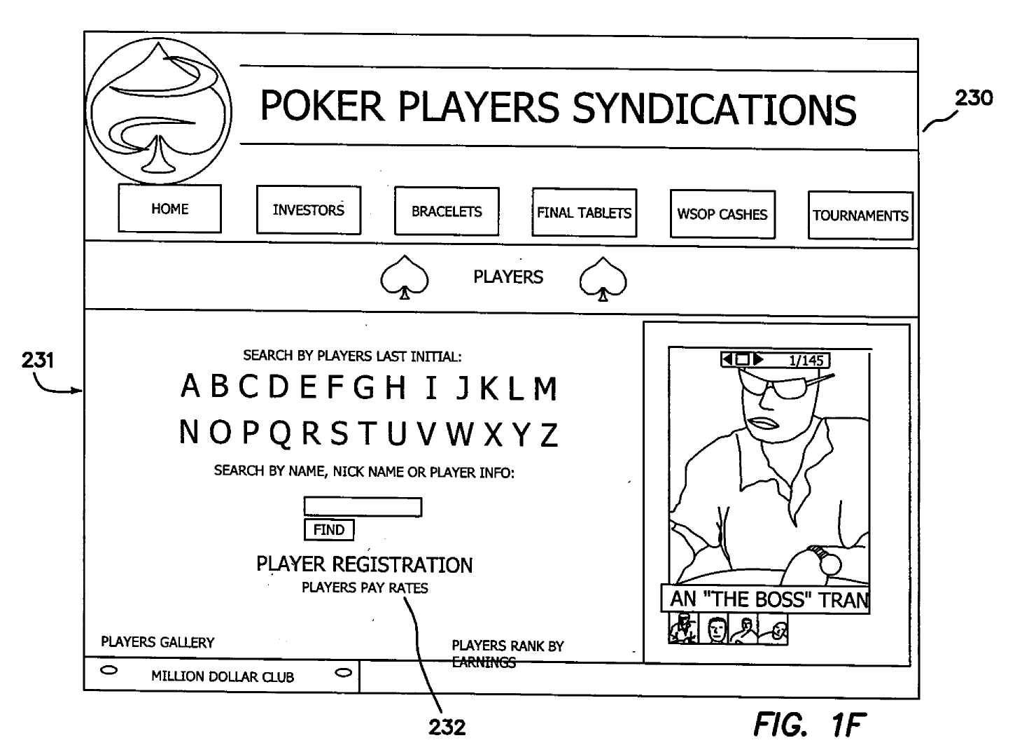

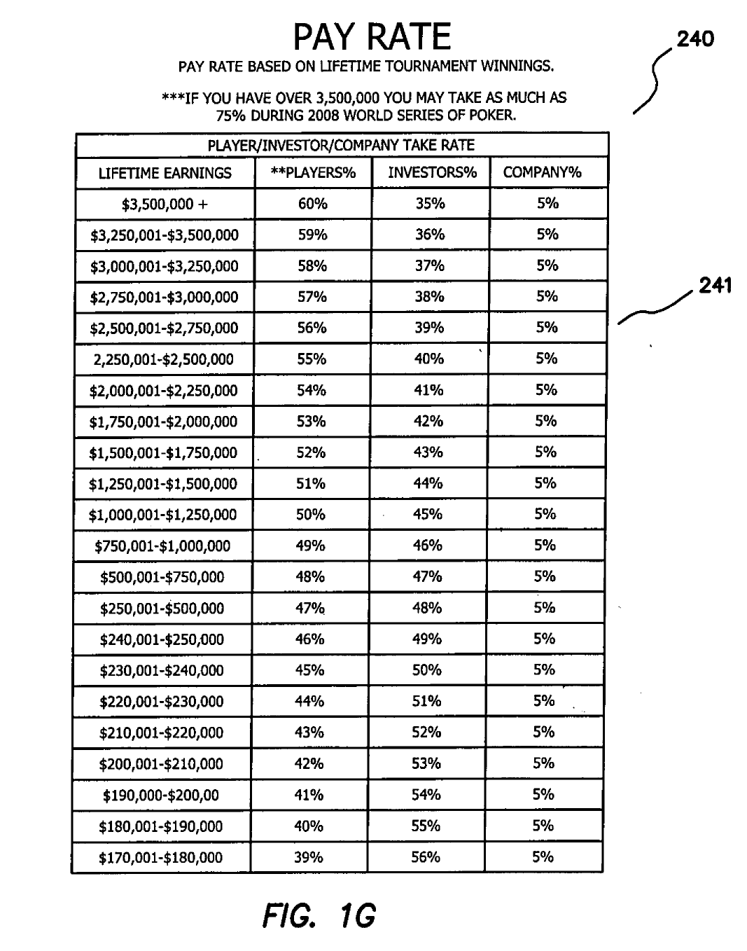

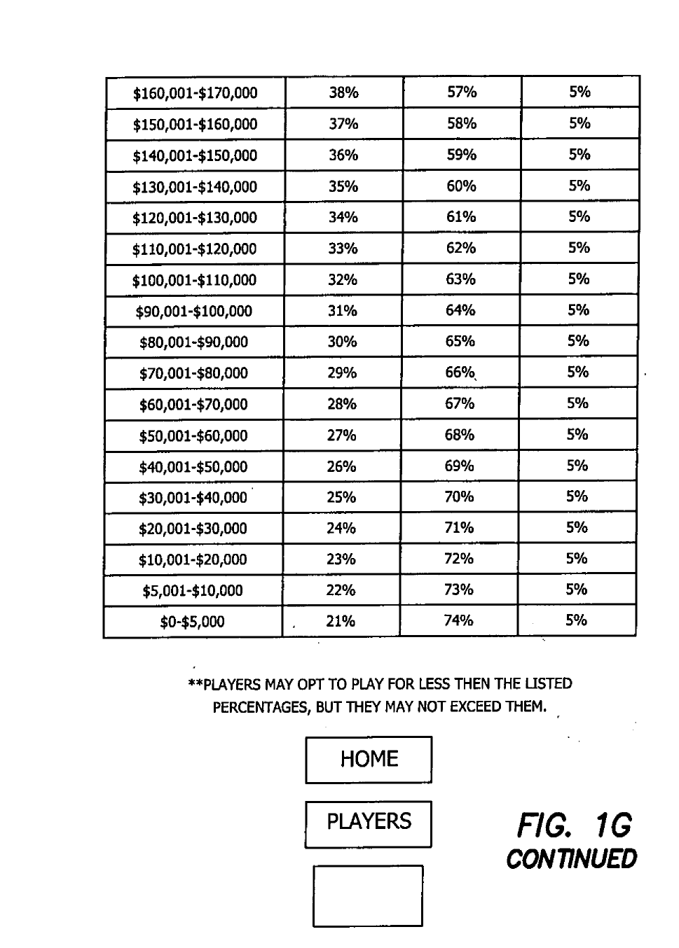

Now referring to FIGS. 1a-1g, a series of exemplary web pages for implementing the embodiments of the present invention are shown. FIG. 1a shows a home page 100 of the dedicated website. The website is accessed via its URL (e.g., www.bapokerbossonline.com). Other URLs may be used and the website may also be accessed via links from other web pages. Links on the home page 100, include a player registration link 110, investor registration link 120, advertisement information link 130, advertisement links 140, merchandise link 150 and general information links 160. Those skilled in the art will understand that the home page 100 may be designed in any manner desired and need not have the appearance shown in FIG. 1a and the same is evident for each and every web page associated with the dedicated website.

Upon clicking on the investor registration link 120, the investor is connected to a investor registration web page 170 as shown in FIG. 1b. The investor registration web page 170 includes an electronic registration form 175 allowing the investor to register. Requested information includes name 181, address 182, country of citizenship 183, phone number 184, e-mail address 185, security question 186, security question answer 187 and password 188. Upon submitting the requested information, the investor is linked to an investment page (not shown) to input credit or debit card information. Investors may also send checks, money orders or wire money to the website operator. Such payment means may take longer since the money must be verified and/or transmitted. Also, if instituted, any investor registration fee is paid at the time the investor registers.

Upon clicking on the player registration link 110, the player is connected to a poker player registration web page 190 as shown in FIG. 1c. The poker player registration web page 190 includes an electronic registration form allowing the poker player to register. Requested information includes name 191, nick name 192, address 193, country of citizenship 194, e-mail address 195, phone number 196, marital status 197, children 198, hobbies 199, experience 200, favorite poker game 201, best poker game 202, favorite music 203, favorite casino 204, most respected player 205, online bio available 206 and player summary 207. While the form seeks to capture player information, it is also conceivable that a player profile link may be accessed by a player such that the player may customize his or her profile by sending, for example, a pre-prepared resume of experience including lifetime earnings and tournament finishes. The website operator may also provide sample player profiles which assists the player in providing information. Such information, at least for well-known professional players may also be collected or imported from third party websites such as www.cardplayer.com which routinely tracks such information. Along with submitting the requested information, players send photos of themselves for use on the website. Upon submitting the requested information, players are connected to a fee payment page (not shown). The player is then able to input credit or debit card information to pay the registration fee. Poker players may also send checks, money orders or wire money to the website operator. In one embodiment, poker players pay a one-time registration fee (e.g., $500) but it is not mandatory to practicing the embodiments of the present invention.

Once the poker player is registered, he or she is able to access a player tournament input web page 210 as shown in FIG. 1d. All scheduled poker tournaments 211 for a pre-established upcoming time period (e.g., 2 months) are listed on web page 210. The player is free to check a box 212 representing one or more tournaments he or she is entering and for which he or she is soliciting investor backing. Also, in one embodiment, players are able to enter how much of the entry fee he or she is interested in receiving from investor backing. The player may seek 25%, 50%, 100% or any other suitable amount. After making all desired entries, the player can save the information via a submit icon 213. Of course, the player is free to return to the player tournament input web page 210 as often as desired to amend the input information. In one embodiment, once investor money has been received for a specified tournament, the player cannot modify his or her corresponding entry. Based on the tournament schedule information input by the players, investors access player schedules via player tournament schedule link 160-5. An upcoming tournament link 214 links players and investors to a web page 220 listing upcoming tournaments 221.

Clicking on the player tournament schedule link 160-5, links the investor to tournament schedule web page (not shown) which allows poker players or tournaments to be searched via a search box. A search reveals the tournaments the subject player intends to enter, the entry fee and the remaining amount of the entry fee available for investment. The investor is now able to select a tournament and input an amount of money he or she would like to invest on this player and on which tournament. Once the investor inputs the dollar amount, the system verifies that the investor has the requisite amount of money in his or her escrow account, and if so, the investment is recorded and the funds in the investor's escrow account are designated or earmarked for the specific player and tournament. The input information is saved by clicking on a save link. The funds however need not be removed from the escrow fund immediately but may be held until a time closer to the time of the tournament.

Investors may monitor their investment portfolio by clicking on an investor account status link which connects the investor to an investment status web page (not shown). Each of the players backed by the investor, tournaments and investment amounts are listed thereon. In addition, a total remaining funds window allows the investor to track remaining investor funds. Any winnings from tournaments to which the investor is entitled are also reflected in the remaining funds window. The funds may be reinvested or cashed out as desired by the investor.

FIG. 1f shows a player search web page 230. The web page 230 includes a search tool 231 which allows investors and players to search for players. A Players Pay Rates link 232 links players and investors to web page 240 shown in FIG. 1g detailing percentage breakdowns 241 for players, investors and operator. The breakdowns are based on lifetime earnings of the players. As shown, the greater the lifetime earnings for a given player, the more the player shares in winnings and the less the investor receives and the lower the lifetime earnings of the player the less the player receives and the more the investor receives. As shown, the operator of the method receives a fixed fee of 5%. In other embodiments, the breakdown may be reversed or fixed across the board. Also, the operator may receive more or less than 5%.

Poker players and investors may receive e-mails or other communications automatically in response to investor money being received on their behalf or poker player status in tournaments wherein the investor has backed the poker player, respectively.

Although the invention has been described in detail with reference to several embodiments, additional variations and modifications exist within the scope and spirit of the invention as described and defined in the following claims.

I claim:

1. A method of conducting a poker player investor scheme comprising:
via a computer:
providing poker players with the ability to register for an opportunity to receive financial backing from third parties;
providing said third parties with access to registered poker players and corresponding events which said poker players intend to enter;
providing means for said third parties to fund one or more poker players of their choice wherein said funding is used to pay all, or portions of, entry fees associated with events to be participated in by the one or more funded poker players; and
providing said third parties with a percentage of any winnings realized by the corresponding funded poker players.

2. The method of claim 1 further comprising providing a dedicated website to facilitate providing poker players with the ability to register for an opportunity to receive financial backing from third parties.

3. The method of claim 1 further comprising providing a dedicated website to facilitate providing said third parties with access to registered poker players and corresponding events which said poker players intend to enter.

4. The method of claim 1 further comprising providing a dedicated website to facilitate providing means for said third parties to fund one or more poker players of their choice wherein said funding is used to pay all, or portions of, entry fees associated with events to be participated in by the one or more funded poker players.

5. The method of claim 1 further comprising associating said percentage of winnings provided to said third parties with an amount of funding relative to the entry fee of the tournament during which winnings are realized.

6. The method of claim 1 further comprising establishing procedures for directly acquiring tournament winnings from a tournament organizer to pay directly to investors.

7. The method of claim 1 wherein said means for said third parties to fund one or more poker players includes wire transfer, credit card, debit card, money order, check and cash.

8. The method of claim 1 further comprising permitting poker players to advertise skills and past results.

9. The method of claim 1 further comprising providing a percentage of player winnings to an operator facilitating the method.

10. A computer storage medium comprising:
code for allowing poker players to register for an opportunity to receive financial backing from third parties;
code for providing said third parties with access to registered poker players and corresponding events which said poker players intend to enter; code for providing means for said third parties to fund one or more poker players of their choice wherein said funding is used to pay all, or portions of, entry fees associated with events to be participated in by the one or more funded poker players; and
code for providing said third parties with a percentage of any winnings realized by the corresponding funded poker players.

11. The computer storage medium of claim 10 further comprising code for associating said percentage of winnings provided to said third parties with an amount of funding provided for the entry fee by said third parties.

12. The computer storage medium of claim 10 further comprising code for managing funding including wire transfer, credit card, debit card, money order, check and cash.

13. The computer storage medium of claim 10 further comprising code for operating a dedicated website to facilitate providing said third parties with access to registered poker players and corresponding events which said poker players intend to enter.

14. The computer storage medium of claim 10 further comprising code for operating a dedicated website to facilitate providing means for said third parties to fund one or more poker players of their choice wherein said funding is used to pay all, or portions of, entry fees associated with events to be participated in by the one or more funded poker players.

15. The computer storage of claim 10 further comprising code for operating a dedicated website to facilitate providing means for said third parties to fund one or more poker players of their choice wherein said funding is used to pay all, or portions of, entry fees associated with events to be participated in by the one or more funded poker players.

16. The computer storage medium of claim 10 further comprising code associating said percentage of winnings provided to said third parties with an amount of funding relative to the entry fee of the tournament during which winnings are realized.

17. The computer storage medium of claim 10 further comprising code for providing a percentage of player winnings to an operator facilitating the method.

18. A computer programmed to:
allow poker players to register for an opportunity to receive financial backing from third parties;
provide said third parties with access to registered poker players and corresponding events which said poker players intend to enter;
provide means for said third parties to fund one or more poker players of their choice wherein said funding is used to pay all, or portions of, entry fees associated with events to be participated in by the one or more funded poker players; and
to provide said third parties with a percentage of any winnings realized by the corresponding funded poker players.

19. The computer of claim 18 wherein said percentage of winnings provided to said third parties is associated with an amount of funding provided for the entry fee by said third parties.

20. The computer of claim 18 further programmed to present a dedicated website to facilitate providing said third parties with access to registered poker players and corresponding events which said poker players intend to enter.

21. The computer of claim 18 further programmed to present a dedicated website to facilitate providing means for said third parties to fund one or more poker players of their choice wherein said funding is used to pay all, or portions of, entry fees associated with events to be participated in by the one or more funded poker players.

22. The computer of claim 18 further programmed to present a dedicated website to facilitate providing means for said third parties to fund one or more poker players of their choice wherein said funding is used to pay all, or portions of, entry fees associated with events to be participated in by the one or more funded poker players.

23. The computer of claim 18 further programmed to provide a percentage of player winnings to an operator facilitating the method.
